(19) United States
(12) Patent Application Publication
(10) Pub. No.: US 2015/0212773 A1
(43) Pub. Date: Jul. 30, 2015

(54) METHOD FOR MANAGING A PLURALITY OF IMAGE PROCESSING DEVICES

(71) Applicant: OCE-TECHNOLOGIES B.V., Venlo (NL)

(72) Inventors: Abraham THIJSSEN, Vierlingsbeek (NL); Wilhelmus J.E.G. VERHOFSTAD, Vierlingsbeek (NL)

(73) Assignee: OCE-TECHNOLOGIES B.V., Venlo (NL)

(21) Appl. No.: 14/681,804

(22) Filed: Apr. 8, 2015

Related U.S. Application Data
(63) Continuation of application No. PCT/EP2013/071001, filed on Oct. 9, 2013.

(30) Foreign Application Priority Data
Oct. 9, 2012 (EP) 12187843.3

(51) Int. Cl. G06F 3/12

(52) U.S. Cl. CPC G06F 3/1259; G06F 3/1285; G06F 3/1229; G06F 3/1292

(57) ABSTRACT

A computer implemented method is provided for managing a plurality of image processing devices, the method comprising the steps of: an image processing device sending a status update to a monitoring device, the monitoring device having a first location; determining a second location of a mobile device; determining a monitoring distance between the second location of the mobile device and the first location of the monitoring device; and determining in response to the monitoring distance whether to issue a warning on the mobile device concerning the status update of the image processing device. The method provides that the mobile device is not overwhelmed by warnings regarding status updates from the image processing devices.

### FIELD OF THE INVENTION

The present invention relates to a computer implemented method for managing a plurality of image processing devices. The present invention further relates to a computer-program product that executes the method. The present invention further relates to a data carrier comprising such computer-program product. The present invention further relates to a management system for managing a plurality of image processing devices. The present invention further relates to a mobile device and a monitoring system for such management system.

### BACKGROUND OF THE INVENTION

In a known method an image processing device sends a status update to a monitoring device. Typical status updates comprise information on errors that occurred, warnings raised and other alerts. For example the image processing device communicates the paper low warnings, out-of-paper errors, toner low warnings, out-of-toner errors, paper jam errors, etc. The monitoring device collects the status updates send by all image processing devices, which are connected to the monitoring device.

An operator is regularly using the monitoring device. Furthermore the operator is using a mobile device. The status updates are sent to the mobile device in order to warn the operator about the status updates of the image processing devices. In this way the operator may quickly respond to a status update of the image processing device in case needed, independent where the operator is present at that time. However the operator might be overwhelmed on his mobile device by the number of status updates. This might result in the operator paying attention to one status update, while overlooking another status update. Furthermore all status updates are shown on the mobile device, even at the time the operator is using the monitoring device.

### SUMMARY OF THE INVENTION

It is accordingly an object of the present invention to overcome this drawback.

This object is attained by providing a computer implemented method for managing a plurality of image processing devices, the method comprising the steps of: a) an image processing device sending a status update to a monitoring device, the monitoring device having a first location; b) determining a second location of a mobile device; c) determining a monitoring distance between the second location of the mobile device and the first location of the monitoring device; and d) determining in response to the monitoring distance whether to issue a warning on the mobile device concerning the status update of the image processing device.

The image processing device, such as a printer or a scanner, communicates status updates to the monitoring device. The image processing device may further comprise a finishing equipment device for post processing an image on a recording substrate, such as a laminating device, a cutter machine, a varnish machine, etc. The monitoring device has a first location, which might be stored in a database. The monitoring device may be a workstation or personal computer which is regularly used by an operator. The mobile device is wirelessly connected to the monitoring device. The mobile device may be authenticated to be used by an operator of the monitoring device. For example, the operator may manually identify the mobile device on the monitoring device. A second location of the mobile device may vary frequently. The second location is determined, for example by using GPS functionality installed on the mobile device. Alternatively the second location of the mobile device may be determined by a Wireless Access point (WAP), when the mobile device is connected to a wireless Local Area Network. In particular the second location of the mobile device may be determined by identifying a media access control (MAC) address of the mobile device. In a specific embodiment the second location of the mobile device may be determined by a triangulation method with a plurality of radio stations, for example by using Wi-Fi triangulation.

A monitoring distance is determined based on the second location of the mobile device and the first location of the monitoring device. The monitoring distance may be a shortest distance between the first location and the second location, Alternatively the monitoring distance may be a shortest travel path of the operator to monitoring device, which is optionally corrected with a bypass route when an obstacle blocks the shortest path. The accuracy of determining the second location of the mobile device may be suitably optimised in order to accurately determine the monitoring distance. The second location of the mobile device may be determined by the mobile device and/or may be determined by the monitoring device.

In the warning determination step d) in response to the monitoring distance it is determined whether to issue a warning on the mobile device concerning the status update of the image forming device. Issuing a warning may for example mean that the monitoring device may send only a warning to the mobile device in response to a certain monitoring distance. Alternatively the monitoring device may send all status updates to the mobile device, wherein a warning concerning a status update is only shown to the operator on the mobile device in response to a certain monitoring distance. The monitoring distance is a relevant criterion for the warning. For example when the mobile device is near to the monitoring device, the operator may wish not the receive a warning on the status updates on the mobile device. Instead the operator may frequently use the monitoring device to monitor the status updates. In this way the mobile device is not constantly overwhelmed by information from status updates from maybe tens of image processing devices.

In an embodiment of the method, the warning determination step d) comprises issuing the warning in case the monitoring distance is larger than a monitoring threshold distance. This provides that the operator is warned on his mobile device when he is located too far from the monitoring device.

In an embodiment of the method, the warning determination step d) further comprises not issuing the warning in case the monitoring distance is smaller than the monitoring threshold distance. For example this embodiment provides that the operator is not disturbed in his activities by a warning on the mobile device when he is close enough to the monitoring device to be able to frequently monitor the status updates on the monitoring device.

In a further embodiment of the method, the method further comprises the step of: e) determining the monitoring threshold distance in response to the status update send by the image processing device, wherein the step is prior to the warning determination step d). For example the monitoring threshold distance may be adjusted according to how much time it will take before the status results in a status of the image processing device that requires immediate attendance. Furthermore the monitoring threshold distance may depend on the image processing device. For example a monitoring threshold distance may be set zero for any status update send by a default used image processing device, which is used very frequently.

In an embodiment of the method, the image processing device has a third location and the method further comprises the steps of: f) determining an operator distance between the third location of the image processing device and the second location of the mobile device; and g) determining in response to the operator distance whether to issue a warning on the mobile device concerning the status update of the image processing device. The operator distance is, for example, a shortest distance between the location of the mobile device and the location of the image processing device. In response to the operator distance it is determined whether to issue a warning on the mobile device concerning the status update of the image forming device. For example the monitoring device may issue only a warning on the mobile device in response to a certain operator distance. The operator distance determines how much time an operator would need to reach the image processing device in order to attend to the incident.

In an embodiment of the method, step g) comprises issuing the warning in case the operator distance is larger than a operator threshold distance. This provides that the warnings on the mobile device are suppressed for which the status update is not yet relevant for the operator to pay attention to.

In an embodiment of the method, step g) further comprises not issuing the warning in case the operator distance is smaller than the operator threshold distance. For example the operator may not be warned on the mobile device in case he is close enough to the image processing device to observe the status of the image processing device directly.

In a further embodiment of the method, the method further comprises the step of: h) determining the operator threshold distance in response to the status update send by the image processing device, wherein step h) is prior to step g). For example the operator threshold distance may be adjusted according to how much time it will take before the status results in a status of the image processing device that requires immediate attendance. For example a paper low status update may indicate a typical response time until an out of-paper error occurs. Furthermore a preparing time may also be taken into account, for example the time to collect an amount of paper in order to replenish the paper station. In particular a status update which requires immediate attention, such as a paper jam, may have high priority and accordingly the operator threshold distance may be set very low or zero. Furthermore the monitoring threshold distance may depend on the image processing device. For example a operator threshold distance may be set zero for any status update send by a default used image processing device, which is used very frequently.

In an embodiment of the method, step g) further comprises not issuing the warning in case the operator distance is larger than a domain threshold distance. This is advantageous for an operator leaving a domain or a site and not being able to respond to a status update. For example when the operator is travelling to another site.

In an aspect of the present invention a computer-program product is provided that executes the method according to the invention when executed on a processor. The computer-program product may be installed on the monitoring device, may be installed on the mobile device, etc.

In an aspect of the present invention a data carrier is provided comprising the computer-program product that executes the method according to the invention when executed on a processor.

In an aspect of the present invention a management system is provided for managing a plurality of image processing devices, comprising: at least one image processing devices comprising communication means for sending status updates; a monitoring device comprising communication means for receiving status updates from the plurality of image processing devices; a mobile device comprising communication means for wirelessly communicating with the monitoring device; the management system further comprising: a storage means for storing received status updates; a mobile device location means for determining a location of the mobile device; a monitoring distance determination means for determining a monitoring distance between the location of the mobile device and a location of the monitoring device; and an issue decision means configured for, in response to the monitoring distance, deciding whether to issue a warning on the mobile device concerning the status of the image processing device.

The monitoring device may be a workstation or personal computer which is regularly used by an operator. The mobile device may be a personal digital assistant, a tablet computer, a laptop or a mobile phone which is used by the same operator. The storage means may be implemented in the monitoring device and for may be implemented in the mobile device. The mobile device location determination means may also be implemented in the monitoring device and for may be implemented in the mobile device. The issue decision means may be implemented in the monitoring device and the warning may be send to the mobile device based on the result of the issue decision means. This has the advantage that the communication between the monitoring device and the mobile device is used only when needed. The issue decision means may also be implemented in the mobile device, wherein the status updates are all send to the mobile device and the issuing of a warning on the mobile device is based on the result of the issue decision means. This provides the advantage that the information regarding the status updates is always available on the mobile device, even when the communication between the mobile device and the monitoring device is disrupted. For example if the mobile device is moved outside a monitoring threshold distance the mobile device may decide to issue a warning regarding a status update, which is already stored on the mobile device, even if the communication with the monitoring device is at that time blocked.

In an embodiment of the management system, the management system further comprises: an operator distance determination means for determining an operator distance between the location of the mobile device and a location of the image processing device; and wherein the issue decision means is further configured for, in response to the operator distance, deciding whether to issue a warning on the mobile device concerning the status of the image processing device. Preferably the operator distance determination means is implemented on the mobile device.

In a specific embodiment, the present invention provides a mobile device as described above with regard to the management system.

In a specific embodiment, the present invention provides a monitoring device as described above with regard to the management system.

In an aspect of the invention a computer implemented method is provided for managing a plurality of image processing devices, the method comprising the steps of: a) an image processing device sending a status update to a monitoring device, the image processing device having a third location; b) determining a second location of a mobile device; f) determining an operator distance between the third location of the image processing device and the second location of the mobile device; and g) determining in response to the operator distance whether to issue a warning on the mobile device concerning the status update of the image processing device. The operator distance is, for example, a shortest distance between the location of the mobile device and the location of the image processing device. In response to the operator distance it is determined whether to issue a warning on the mobile device concerning the status update of the image forming device. For example the monitoring device may issue only a warning on the mobile device in response to a certain operator distance. The operator distance determines how much time an operator would need to reach the image processing device in order to attend to the incident. This has the advantage that the mobile device is not automatically overwhelmed with warnings concerning the status updates of the imaging device. A warning concerning the status update may be send by the image processing device to the mobile device or may be send by the monitoring device to the mobile device.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

Hereinafter, the present invention is further elucidated with reference to the appended drawings showing non-limiting embodiments and wherein

FIG. 1 schematically shows a diagram of an embodiment of a system according to the present invention.

FIGS. 2A and 2B schematically show two embodiments of the method according to the present invention, thereby illustrating a monitoring distance and an operator distance.

FIG. 3 shows a flow diagram of a method according to the present invention.

FIG. 4A schematically shows an embodiment of the method according to the present invention, thereby illustrating a variation in operator threshold distance.

FIG. 4B shows a flow diagram for adjusting an operator threshold distance for the embodiment shown in FIG. 4A.

FIG. 5 schematically shows an embodiment of the user interface of an embodiment according to the present invention.

### DETAILED DESCRIPTION OF EMBODIMENTS

The present invention will now be described with reference to the accompanying drawings, wherein the same reference numerals have been used to identify the same or similar elements throughout the several views.

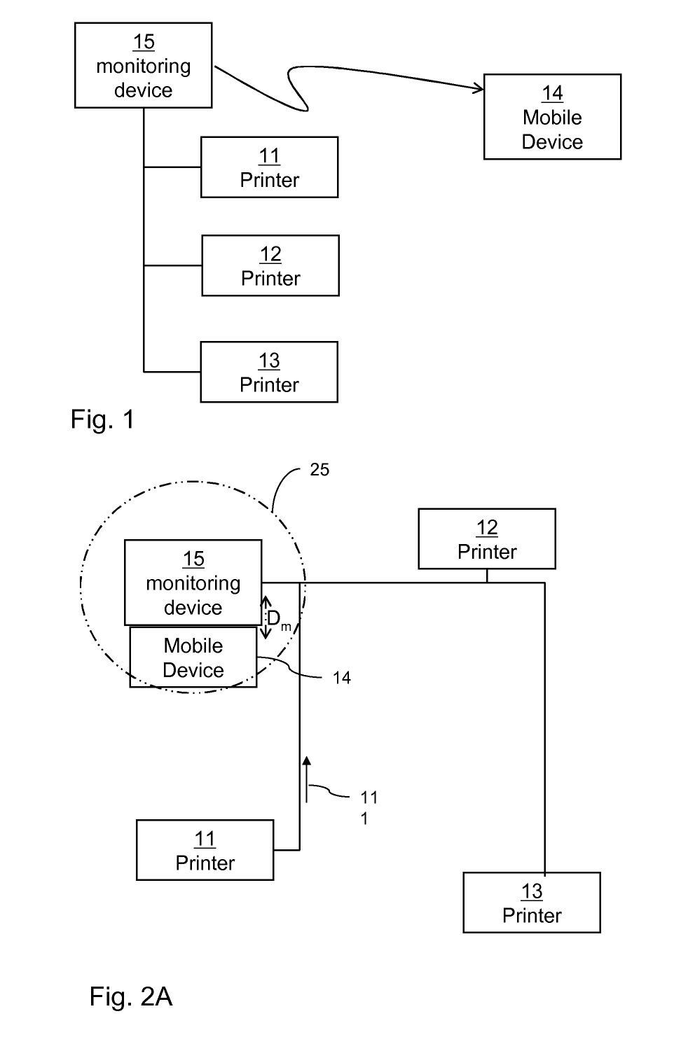

FIG. 1 shows a typical system according to the present invention comprising a number of printers 11, 12, 13. These printers are connected through a network to a monitoring device 15. The printers 11, 12, and 13 send status updates to the monitoring device 15. Typical status updates comprise information on errors that occurred, warning raised and other alerts. For example, the printers 11, 12, 13 communicate the number of paper sheets left in the paper trays, paper low warnings, out-of-paper errors, toner low warnings, out-of-toner errors, paper jam errors, etc. The monitoring device 15 stores these status updates. Each of the printers 11, 12 and 13 have a location, which is known to the monitoring device 15 or is communicated to the monitoring device 15 at the time of sending the status update. A mobile device 14 is wirelessly connected to the monitoring device 15. In case a status update is received by the monitoring device 15, an actual location of the mobile device 14 is determined. The location of the monitoring device 15 is known. A monitoring distance is determined between the location of the mobile device and the location of the monitoring device. Depending on the monitoring distance it is decided whether to issue a warning on the mobile device concerning the status update of the image processing device.

Furthermore in an embodiment an operator distance is determined between the location of the image processing device, which has send the status update, and the location of the mobile device 14. Depending on the operator distance and/or the monitoring distance it is decided whether to issue a warning on the mobile device concerning the status update of the image processing device.
In an embodiment (not shown) one or more of the printers 11, 12, 13 shown in FIG. 1 may alternatively be a finishing equipment device for post processing an image on a recording substrate, such as a laminating device, a cutter machine or a varnish machine. Said finishing equipment device is configured for sending a status update to the monitoring device 15.

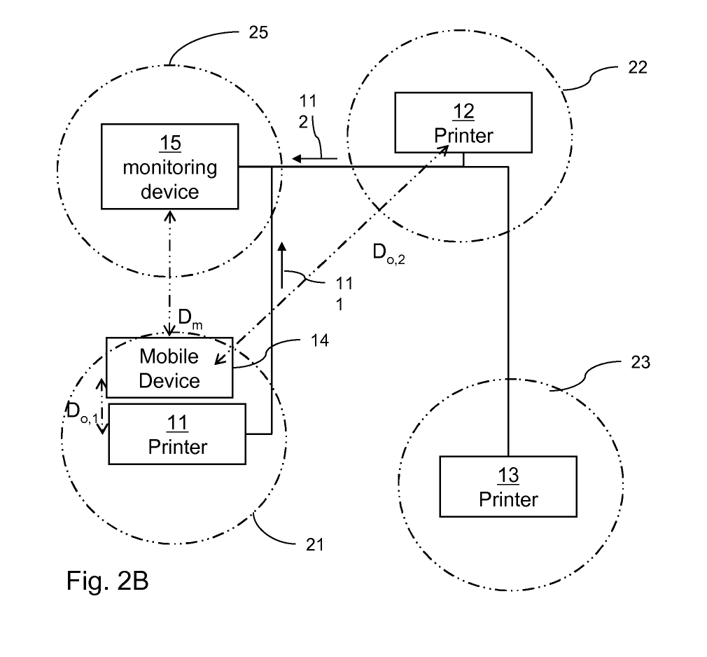

FIGS. 2A and 2B schematically show two embodiments of the method according to the present invention, thereby illustrating a monitoring distance and an operator distance.

FIG. 2A schematically illustrates a monitoring distance according to the present invention. The locations of each of the printers 11, 12 and 13 and of the monitoring device 15 is schematically illustrated in a plan view. A status update 111 is send by printer 11 to the monitoring device 15. The mobile device 14 is located adjacent to the monitoring device 15 as the operator is using the monitoring device 15. A monitoring distance Dₘ between the actual location of the mobile device 14 and the monitoring device 15 is determined to be approximately zero. It is determined that the monitoring distance Dₘ is smaller than a monitoring threshold distance 25, which is schematically illustrated as a circular limit, which is centered with respect to the monitoring device 15. In response to the monitoring distance Dₘ being smaller than the monitoring threshold distance 25 it is decided not to issue a warning on the mobile device 14 concerning the status update of the printer 11. Instead it is expected that the operator may use the monitoring device 15 in order to view the status update. Alternatively, in case the mobile device would be located outside the monitoring threshold distance 25, it would be decided to issue a warning on the mobile device 14 concerning the status update of the printer 11.

In FIG. 2B schematically illustrates an operator distance according to the present invention. The locations of each of the printers 11, 12 and 13 and of the monitoring device 15 are schematically illustrated in a plan view. A status update 111 is send by printer 11 to the monitoring device 15. The mobile device 14 is located adjacent to the printer 11 as the operator is attending the printer 11. It is determined that the monitoring distance Dₘ is larger than a monitoring threshold distance 25, which is schematically illustrated as a circular limit, which is centered with respect to the monitoring device 15. A operator distance D_{0,1} between the actual location of the mobile device 14 and the printer 11 is determined to be approximately zero. It is determined that the operator distance D_{0,1} is smaller than a operator threshold distance 21, which is schematically illustrated as a circular limit, which is centered with respect to the printer 11. Accordingly it is decided not to issue a warning on the mobile device 14 concerning the status update 111 of the printer 11.

At the same time a status update 112 is send by printer 12 to the monitoring device 15. An operator distance D_{0,2} between the actual location of the mobile device 14 and the printer 12 is determined. It is determined that the operator distance D_{0,2} is larger than an operator threshold distance 22, which is schematically illustrated as a circular limit, which is centered with respect to the printer 12. Accordingly it is decided to issue a warning on the mobile device 14 concerning the status update 112 of the printer 12. In this way the operator is informed in time about the status update 112 of the printer 12 even when the operator is not near to the monitoring device 15 or near to the printer 12.

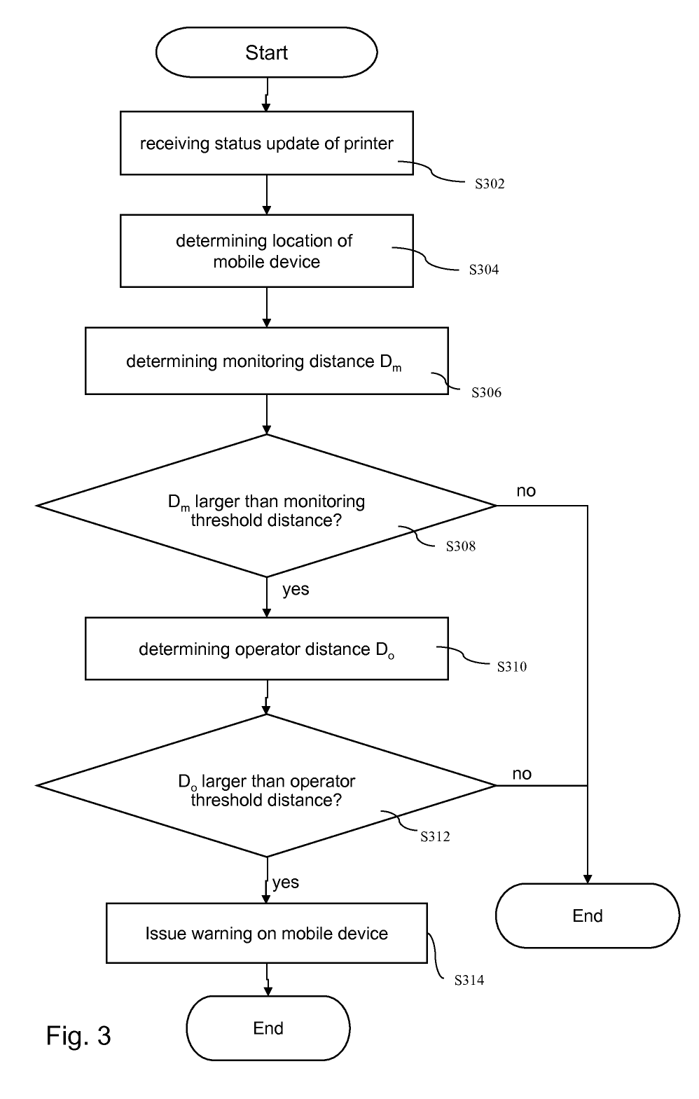

FIG. 3 shows a flow-chart of a method according to the present invention. The method illustrated here can be used in any of the embodiments as shown in FIG. 2A-2B. In step S302 of the method a status update of a printer is received by the monitoring device 15. In step S304 a location of the mobile device 14 is determined. In step S306 a monitoring distance Dₘ between the location of the mobile device 14 and the monitoring device 15 is determined. In step S308 it is judged whether the monitoring distance Dm is larger than a monitoring threshold distance. In case no, it is decided not to issue a warning on the mobile device 14 and the process is ended. In case yes, in step S310 an operator distance Dₒ between the location of the mobile device and the location of the printer of the status update is determined. In step S312 it is judged whether the operator distance Dₒ is larger than an operator threshold distance. In case no, it is decided not to issue a warning on the mobile device 14 and the process is ended. In case yes, in step S314 a warning is issued on the mobile device concerning the status update of step S302 of the printer.

In this method either the status update of step 302 may be send to the mobile device 14 before step S308 and stored on the mobile device 14 without directly issuing a warning on the mobile device 14 or the status update of step 302 may be stored on the monitoring device 15 and send to the mobile device 14 after step S314 when deciding to issue the warning on the mobile device 14.

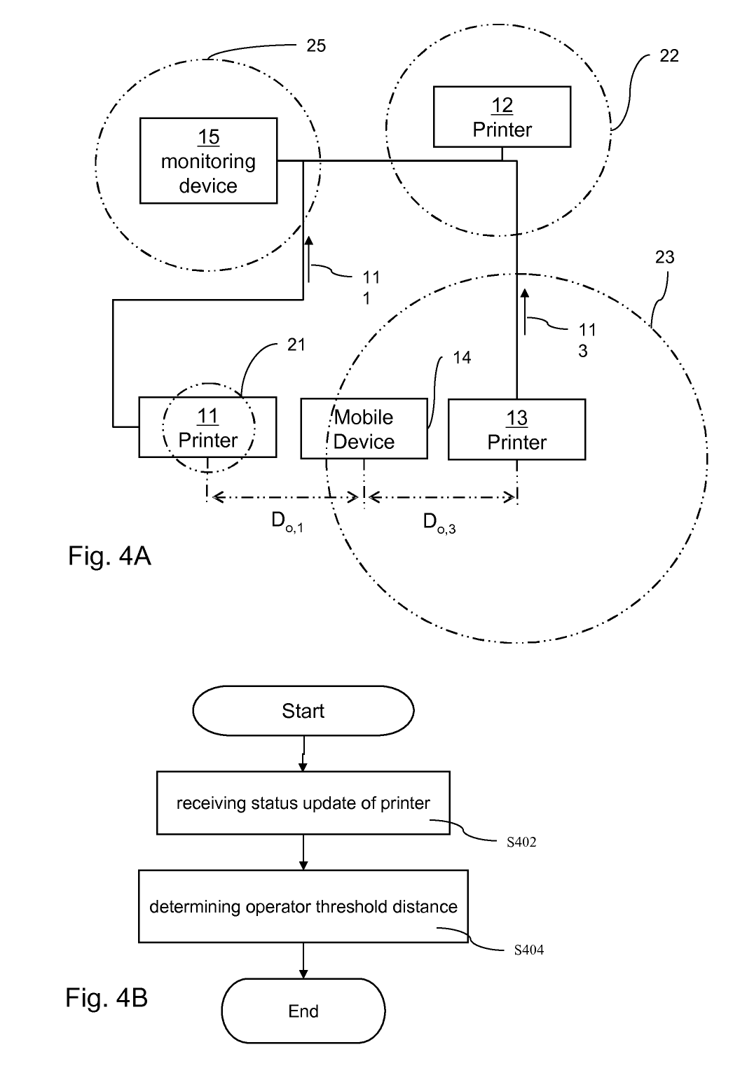

FIG. 4A schematically shows an embodiment of the method according to the present invention, thereby illustrating a variation in operator threshold distance. The locations of each of the printers 11, 12 and 13 and of the monitoring device 15 are schematically illustrated in a plan view. A status update 111 is sent by printer 11 to the monitoring device 15. At the same time a status update 113 is sent by printer 13 to the monitoring device 15. The mobile device 14 is located in between the printer 11 and the printer 13. It can be seen that a monitoring distance Dₘ between the mobile device 14 and the monitoring 15 is larger than a monitoring threshold distance 25.

An operator distance D_{0,1} between the actual location of the mobile device 14 and the printer 11 is determined and an operator distance D_{0,3} between the actual location of the mobile device 14 and the printer 13. The operator distance D_{0,1} is approximately equal to the operator distance D_{0,3}. The status update 111 of the printer 11 concerns a paper jam error and has a high priority to be attended. Accordingly the monitoring threshold distance 21 is set to be small. The status update 113 of the printer 13 concerns a paper low warning, which does not need immediate attention. Accordingly the monitoring threshold distance 23 is set to be relatively large. I. It can be seen that the operator distance D_{0,1} is larger than the operator threshold distance 21 and it can be seen that the operator distance D_{0,3} is smaller than the operator threshold distance 23. Accordingly it is decided to issue a warning on the mobile device 14 concerning the status update 111 of the printer 11 and not to issue a warning on the mobile device 14 concerning the status update 111 of the printer 11. In this way the attention is given to the paper jam status of printer 11, while the operator is not at the same time disturbed by the paper low status of printer 13. Furthermore at the moment the operator attends printer 11 he is warned about the paper low status of printer 13, as the new location of the mobile device 14 will be moved outside the operator threshold distance 23.

In an alternative embodiment the printer 13 comprises a local warning device, such as a light warning system or a sound warning system, for locally signaling to an operator a status of the printer 13. For example the light warning system may provide a green light for regular operation of the printer 13, an orange light for a medium attention status and a red light for an urgent attention status for the printer. The operator threshold 23 may be suitably selected in response to a warning distance over which the light warning system of the printer 13 is visible to an operator. In this way the warnings on the mobile device are suppressed in case the operator is within warning distance of the light warning system of the printer 13.

FIG. 4B shows a flow diagram for adjusting an operator threshold distance for the embodiment shown in FIG. 4A. In step 402 a status update of a printer is received by the monitoring device 15. In step 404 an operator threshold distance is determined based on the status update. For example for each type of status update a typical response time may be provided in the system, which types of status updates are all stored in a data base. The data base may be predetermined and may be user configurable. The typical response time for the status may comprise the time until the status would lead to a full stop of operation of the printer and the typical response time may comprise a preparing time.

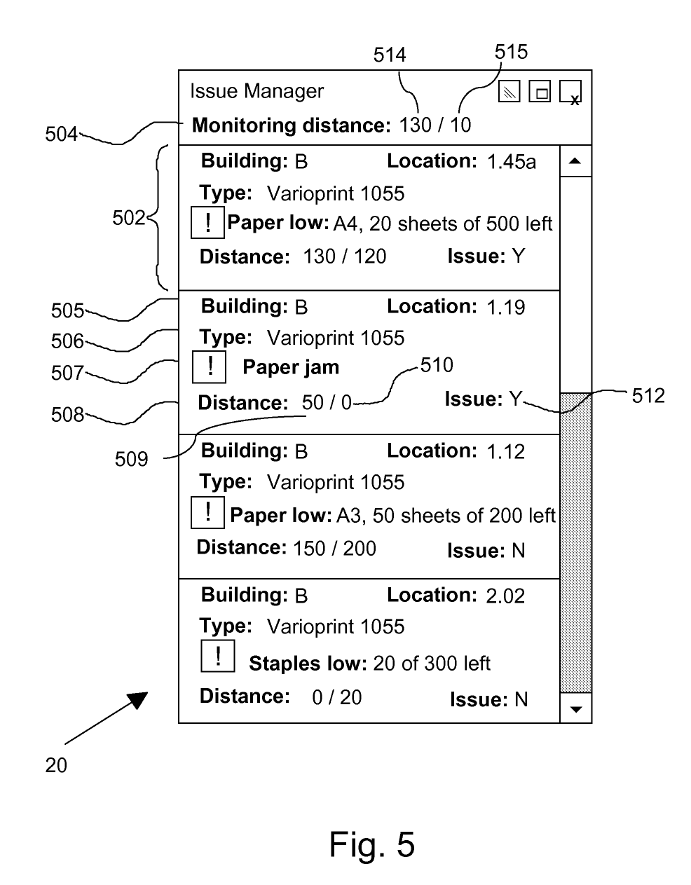

FIG. 5 schematically shows an embodiment of the user interface of an embodiment according to the present invention. The monitoring device 15 displays a issue update list 20 on its display. The issue update list 20 comprises a number of records 502, each for a status update of one of the image processing devices 11, 12, 13. On top a monitoring distance indicator 504 shows an actual monitoring distance 514 between the mobile device 14 and the monitoring device 15 and shows a monitoring threshold distance 515. Every record 502 shows a location 505 of the image processing device 11, 12, 13, the type of device 506, an identifier of the status update 507 informing what action is required and an operator distance indicator 508 showing an actual operator distance 509 to the printer 505 and an operator threshold distance 510. In the example shown two printers are low on paper and need the paper trays to be refilled. One of the printers requires A4 size paper, the other A3 size paper. The operator can see how much paper is left, and how much the trays can hold. Another printer is experiencing a paper jam. The last printer shown is low on staples.

For each status update it is decided whether to issue a warning on the mobile device 14 in response to the monitoring distance and in response to the operator distance. The issue indicator 512 shows whether a warning is issued on the mobile device 14. Those warnings, which are indicated by Y in the issue indicator field 512 are issued on the mobile device 14.

The operator distance for the status update for the last printer is 0, meaning that the operator is present at the printer and the operator is able to observe the status of the printer directly. No warning concerning the staples low warning is issued on the mobile device 14. The operator threshold distance of the paper jam error is 0, meaning that the warning is given a high priority. A warning is issued on the mobile device 14. One of the paper low warnings (A4) is issued on the mobile device 14, while the other paper low warning (A3) is not issued on the mobile device 14.

In a more advanced example, the mobile device 14 shows a map of the building with the location of the image processing device requiring attendance.

A further improvement is that the mobile device 14 includes some identification hardware to identify the image processing device the operator is attending to. For example, the image processing devices may be provided with optical tags, such as barcodes or QR-codes, that are scanned by the mobile device 14. This way, the operator can easily inform the system that he is at the specific location. This facilitates reporting back to the system that work has started on the current issue, and later that the current issue has been resolved. An alternative to optical tags is identification through radio, for example RFID-tags or based on Bluetooth or Near Field Communication technology. This also allows the operator to report back to the system what actions he has performed at a specific image processing device, such as “loaded 1000 sheets of A4”.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.
The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A computer implemented method for managing a plurality of image processing devices, the method comprising the steps of:
a) an image processing device sending a status update to a monitoring device, the monitoring device having a first location;
b) determining a second location of a mobile device;
c) determining a monitoring distance between the second location of the mobile device and the first location of the monitoring device; and
d) determining in response to the monitoring distance whether to issue a warning on the mobile device concerning the status update of the image processing device.

2. The method according to claim 1, wherein step d) comprises issuing the warning in case the monitoring distance is larger than a monitoring threshold distance.

3. The method according to claim 1, wherein step d) further comprises not issuing the warning in case the monitoring distance is smaller than a monitoring threshold distance.

4. The method according to claim 2, wherein the method further comprises the step of:
e) determining the monitoring threshold distance in response to the status update sent by the image processing device, wherein step e) is prior to step d).

5. The method according to claim 1, wherein the image processing device has a third location and the method further comprises the steps:
f) determining an operator distance between the third location of the image processing device and the second location of the mobile device;
g) determining in response to the operator distance whether to issue a warning on the mobile device concerning the status update of the image processing device.

6. The method according to claim 5, wherein step g) comprises issuing the warning in case the operator distance is larger than a operator threshold distance.

7. The method according to claim 5, wherein step g) further comprises not issuing the warning in case the operator distance is smaller than an operator threshold distance.

8. The method according to claim 6, wherein the method further comprises the step of:
h) determining the operator threshold distance in response to the status update sent by the image processing device, wherein step h) is prior to step g).

9. The method according to claim 5, wherein step g) further comprises not issuing the warning in case the operator distance is larger than a domain threshold distance.

10. Computer-program product that executes a method according to claim 1 when executed on a processor.

11. Data carrier comprising the computer-program product that executes a method according to claim 1 when executed on a processor.

12. Management system for managing a plurality of image processing devices, comprising:
at least one image processing device comprising communication means for sending status updates;
a monitoring device comprising communication means for receiving status updates from the plurality of image processing devices;
a mobile device comprising communication means for wirelessly communicating with the monitoring device;
the management system further comprising:
a storage means for storing received status updates;
a mobile device location determination means for determining a location of the mobile device;
a monitoring distance determination means for determining a monitoring distance between the location of the mobile device and a location of the monitoring device; and
an issue decision means configured for, in response to the monitoring distance, deciding whether to issue a warning on the mobile device concerning the status of the image processing device.

13. The management system according to claim 12, wherein the management system further comprises:
an operator distance determination means for determining an operator distance between the location of the mobile device and a location of the image processing device; and
wherein the issue decision means is further configured for, in response to the operator distance, deciding whether to issue a warning on the mobile device concerning the status of the image processing device.

14. Mobile device according to claim 12.

15. Monitoring device according to claim 12.

16. Computer-program product that executes a method according to claim 2 when executed on a processor.

17. Computer-program product that executes a method according to claim 3 when executed on a processor.

18. Computer-program product that executes a method according to claim 4 when executed on a processor.

19. Computer-program product that executes a method according to claim 5 when executed on a processor.

20. Computer-program product that executes a method according to claim 6 when executed on a processor.
